(19) United States
(12) Patent Application Publication
(10) Pub. No.: US 2004/0072044 A1
(43) Pub. Date: Apr. 15, 2004

(54) Direct hydrogen peroxide fuel cell utilizing proton-donating fuel

(76) Inventors: John Rusek, West Lafayette, IN (US); Daniel Prater, West Lafayeette, IN (US)

Correspondence Address: LAW OFFICES OF TOWNSEND & BANTA, 601 Pennsylvania Avenue, N.W., Suite 900, South Building, Washington, DC, 20004, US

(21) Appl. No.: 10/269,046

(22) Filed: Oct. 11, 2002

(51) Int. Cl. H01M 8/10; H01M 4/90; H01M 4/92

(52) U.S. Cl. 429/30; 429/33; 429/43; 429/42

(57) ABSTRACT

A direct hydrogen peroxide/proton-donating-fuel fuel cell for production of electric current by reduction of hydrogen peroxide coupled with oxidation of fuel by means of ion transfer across an ion-conducting polymer electrolyte is provided. In addition, a hydrogen peroxide concentration meter is provided, which may be utilized, for example, for measuring the concentration of hydrogen peroxide in solutions that may contain strong electrolytes or in automated systems such as those to be used with the present fuel cell.

### FIELD OF THE INVENTION

The present invention concerns a direct hydrogen peroxide fuel cell which utilizes a proton-donating fuel. In particular, a direct hydrogen peroxide/proton-donating-fuel fuel cell for production of electric current by reduction of hydrogen peroxide coupled with oxidation of fuel by means of ion transfer across an ion-conducting polymer electrolyte.

### BACKGROUND OF THE INVENTION

In conventional fuel cells containing hydrogen peroxide as the oxidizing agent, as shown in FIG. 1 herein, a metal anode 2 is oxidized along with reduction of the hydrogen peroxide solution 4, causing an electric current to flow from the anode to the cathode through the electrolyte, which is contained within the hydrogen peroxide solution. An alternate method for utilization of hydrogen peroxide involves the decomposition of hydrogen peroxide to water and oxygen, wherein oxygen then acts as oxidant in conventional fuel/oxygen fuel cells, such as the popular hydrogen/oxygen fuel cell; this method can be referred to as indirect hydrogen peroxide reduction.

However, in conventional liquid fuel cells containing H₂O₂, as shown in FIG. 1, the aluminum anode oxidizes to aluminum oxides during reduction of the H₂O₂, with deterioration of performance over time due to poisoning of the metal surface. Moreover, selection of the cathode material is difficult, as only certain cathode materials will effectively reduce H₂O₂ at a desirable rate, i.e., at a rate of reduction which will produce sufficient current, but without undue H₂O₂ decomposition. Additionally, the direct reduction of hydrogen peroxide to water on the cathode surface is the rate-limiting reaction in the production of electricity from hydrogen peroxide, and thus a catalyst is required to achieve sufficient power density. Utilization of noble metal catalysts in this manner facilitates hydrogen peroxide decomposition, releasing oxygen as waste, and thus a decrease in cell efficiency.

### SUMMARY OF THE INVENTION

The inventors of the present invention have earnestly conducted extensive research in order to overcome the deficiencies of the conventional liquid fuel cells containing H₂O₂, as described above, and have discovered a novel direct hydrogen peroxide fuel cell cathode which provides closer to the thermodynamically expected efficiency of hydrogen peroxide. Reduction of hydrogen peroxide is carried out in a separate compartment, the anode and cathode comprise catalysts, and ion transfer occurs through a polymer membrane electrolyte. Several embodiments of such direct methanol-direct hydrogen fuel cell of the present invention are provided as follows:

In a first embodiment of the present invention, a direct hydrogen peroxide fuel cell utilizing proton-donating fuel is provided, comprising:

a first compartment having a first end with at least one input orifice and at least one output orifice disposed therein, and a second open end;

an anode disposed adjacent and in contact with the second open end of the first compartment;

an ion-conducting membrane disposed adjacent to and in contact with the anode;

a cathode disposed adjacent to and in contact with the ion conducting membrane and electrically connected to the anode; and

a second compartment having a first end with at least one input orifice and at least one output orifice disposed therein, and a second open end disposed adjacent to and in contact with the cathode.

In second embodiment of the present invention according to the first embodiment above, the first compartment additionally contains a proton-donating fuel.

In a third embodiment of the present invention according to the first embodiment above, the anode is comprised of a porous and electrically conductive substrate.

In a fourth embodiment of the present invention according to the third embodiment above, the anode further has an ion-conducting polymer impregnated therein.

In a fifth embodiment of the present invention according the first embodiment above, the ion conducting membrane is NAFION.

In a sixth embodiment of the present invention according to the first embodiment above, the cathode is comprised of a metal, an inorganic matrix, or metal containing organic compound, or an enzyme, said enzyme capable of catalyzing the reduction of hydrogen peroxide.

In a seventh embodiment of the present invention according to the first embodiment above, the cathode or anode, or both, contain a metal selected from the group consisting of ruthenium, rhodium, palladium, osmium, iridium and platinum, or a mixture thereof, to catalyze the reduction of hydrogen peroxide or the oxidation of fuel, respectively.

In an eighth embodiment of the present invention according to the sixth and seventh embodiments described above, the cathode further comprises a conductive and porous substrate (for example, fritted or woven carbon and metallic species).

In a ninth embodiment of the present invention according to the first embodiment described above, the cathode is comprised of an enzyme as an electrocatalyst.

In a tenth embodiment of the present invention according to the ninth embodiment above, said enzyme is an enzyme from the peroxidase class of enzymes.

In an eleventh embodiment of the present invention according to the ninth embodiment of the present invention, the cathode further comprises a substrate attached to the enzyme, to facilitate either electron or proton transfer between the electrode and the electrocatalyst, or both.

In a twelfth embodiment of the present invention according to the eleventh embodiment above, the cathode further comprises a conductive binder.

In a thirteenth embodiment of the present invention according to the twelfth embodiment above, the binder is a porous, inert, and ion-conductive polymer.

In a fourteenth embodiment of the present invention according to the first embodiment described above, the cathode is comprised of an organometallic molecule.

In a fifteenth embodiment of the present invention according to the ninth embodiment described above, the cathode is comprised of a catalase.

In a sixteenth embodiment of the present invention according to the fourteenth and fifteenth embodiments above, the cathode further comprises a substrate attached to the organometallic molecule or enzyme.

In an seventeenth embodiment of the present invention according to the first embodiment above, the fuel cell further contains a proton donor liquid reservoir flowably connected to the input orifice of the first compartment, for holding and supplying a proton donor liquid to the fuel cell via the input orifice.

In eighteenth embodiment of the present invention according to the first embodiment above, the fuel cell further contains a proton acceptor liquid reservoir flowably connected to the input orifice of the second compartment, for holding and supplying a proton acceptor liquid to the fuel cell via the input orifice.

In a nineteenth embodiment of the present invention according the eighteenth embodiment above, the proton acceptor fluid contains hydrogen peroxide.

In a twentieth embodiment of the present invention according to the first embodiment above, the fuel cell further contains a receiving reservoir flowably connected to the output orifice of the first compartment.

In a twenty-first embodiment of the present invention according to the first embodiment above, the fuel cell further contains a receiving reservoir flowably connected to the output orifice of the second compartment.

In a twenty-second embodiment of the present invention according to the eighteenth embodiment of the present invention, the proton acceptor liquid reservoir comprises a hydrogen peroxide concentration sensor.

In a twenty-third embodiment of the present invention according to the first embodiment above, the anode comprises dehydrogenases. Said dehydrogenases oxidize hydrocarbons.

In a twenty-fourth embodiment of the present invention according to the first embodiment above, the anode comprises synthetic molecules which display dehydrogenase-like catalytic activity.

In a twenty fifth embodiment of the present invention according to the second embodiment above, the proton-donating fuel is methanol, methane, or a logistic fuel such as gasoline or kerosene, which is combined with water.

In a twenty sixth embodiment of the present invention according to the second embodiment above, the second compartment additionally contains hydrogen peroxide and water.

In a twenty seventh embodiment of the present invention according to the third embodiment above, the porous and electrically conductive substrate is selected from fritted carbon, carbon cloth, fritted metals or woven metals.

In a twenty eighth embodiment of the present invention according to the sixth embodiment above, the metal containing organic compound is selected from the group consisting of metallo-porphyins, chelated metal moieties, organo-metallics.

In a twenty ninth embodiment of the present invention according to the twelfth embodiment above, the conductive binder is comprised of a substituted synthetic zeolite, or a conducting polymer.

In a thirtieth embodiment of the present invention according to the thirteenth embodiment above, the binder is NAFION.

In a thirty first embodiment of the present invention according to the fourteenth embodiment above, the organometallic molecule is selected from among the group consisting of metallo-porphyins, chelated metals and organo-metallic species. Said organometallic molecules have catalytic peroxide reduction properties.

### BRIEF DESCRIPTION OF THE DRAWINGS

FIG. 1 is a cross-sectional view of a conventional liquid fuel cell containing hydrogen peroxide.

FIG. 2 is a cross sectional view of the fuel cell of the present invention.

FIG. 3 is a block diagram of the fuel cell of the present invention.

### DETAILED DESCRIPTION OF THE INVENTION

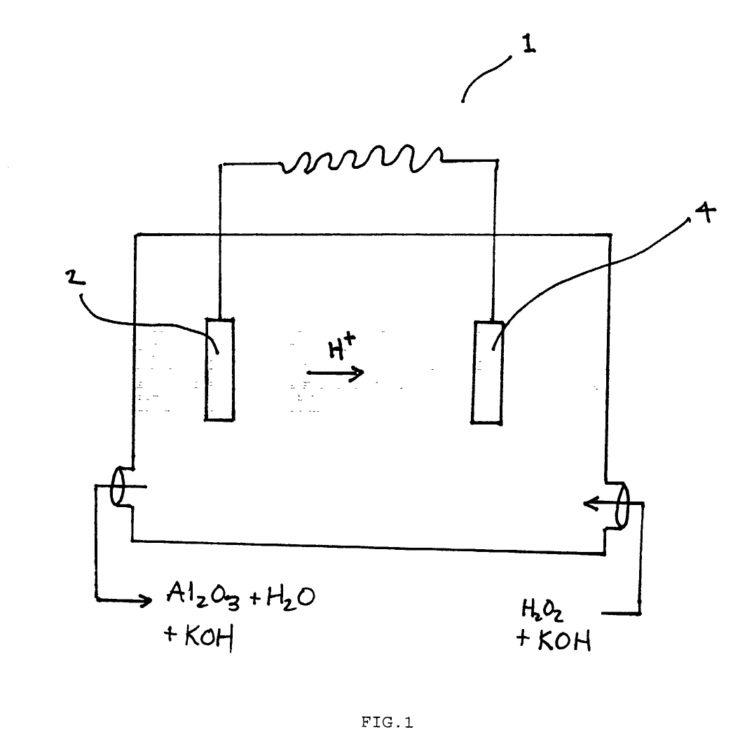

Many conventional fuel cells using hydrogen peroxide are designed so that hydrogen peroxide comes into direct contact with the anode material, and reduces the anode material (usually a metal). Consequently, the liquid hydrogen peroxide constitutes an electrolytic species, and ions are conducted through the electrolyte to the cathode, the site of hydrogen peroxide reduction. Such conventional liquid fuel cells 1, as shown in FIG. 1, containing hydrogen peroxide, have an anode 2 and a cathode 4 immersed in a diluted hydrogen peroxide solution. Generally, the anode 2 is made of a metal such as aluminum, as shown in FIG. 1. The aluminum anode 2 oxidizes to form aluminum oxides and hydrogen peroxide (H₂O₂) is reduced. However, as both the anode and the cathode are exposed to the hydrogen peroxide, excessive decomposition of the hydrogen peroxide occurs, and the anode quickly oxidizes through chemical reaction with hydrogen peroxide or its ions (as opposed to the electrochemical reaction), causing a decrease in performance relatively quickly over time. Further, difficulties arise in that only certain cathodes will reduce hydrogen peroxide in this environment, and satisfactory current production is difficult.

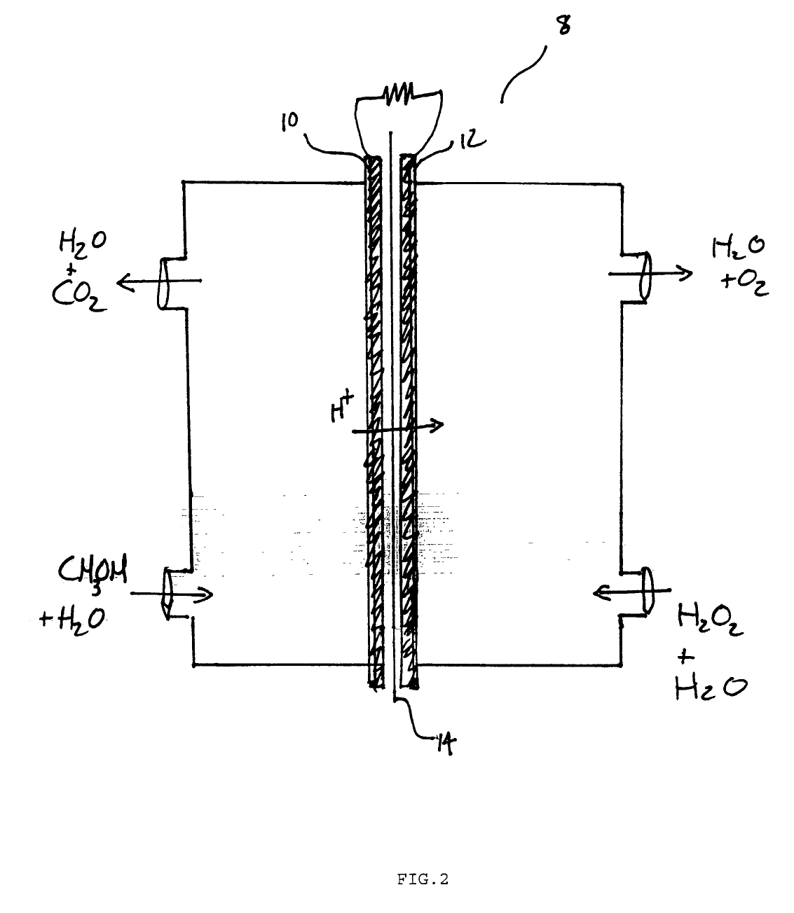

In contrast, the present invention provides a fuel cell 8, as shown in FIG. 2, wherein an electrolyte membrane separates the proton donor from the proton acceptor (hydrogen peroxide), resulting in the reduction of hydrogen peroxide at the cathode and oxidation of the proton donor at the anode. Thus, it is desired that the cathode of the present invention comprise an electrocatalyst that will not heterogeneously decompose hydrogen peroxide.

The anode 10 may be formed of a porous conductive substrate, with a polymer impregnated therein, or coated thereon. Suitable polymers are polymers which allow the transfer of protons therethrough, such as NAFION. In addition, a polymer such as TEFLON may be impregnated therein or coated thereon to provide hydrophobicity to the anode 10, for compatibility with nonpolar fuels. Alternatively, the anode 10 may be formed of dehydrogenases, dehydrogenase-like enzymes, or synthetic dehydrogenase-like enzymes, or be comprised of catalysts such as platinum, ruthenium, and palladium, or a mixture thereof.

The hydrogen-peroxide reduction cathode 12 may comprise platinum-family metals, such as ruthenium, rhodium, palladium, osmium, iridium and platinum, or a mixture thereof. Alternatively, the hydrogen peroxide reduction cathode 12 may be formed of a peroxidase enzyme, an inorganic material, or an organometallic as a hydrogen peroxide reduction catalyst. In another embodiment, the cathode 12 may comprise catalase, an inorganic material, or an organometallic, with display suitable catalase activity.

In addition, the cathode 12 may include carbon paper, or suitable conductive substrate, with porosity preferable to achieve sufficient surface area. An ion-conducting membrane 14 may be placed between the anode 10 and the cathode 12, and the anode 10 and cathode 12 pressed against the proton conducting membrane 14 to form an anode/cathode membrane which effectively divides the fuel cell 8 into separate compartments.

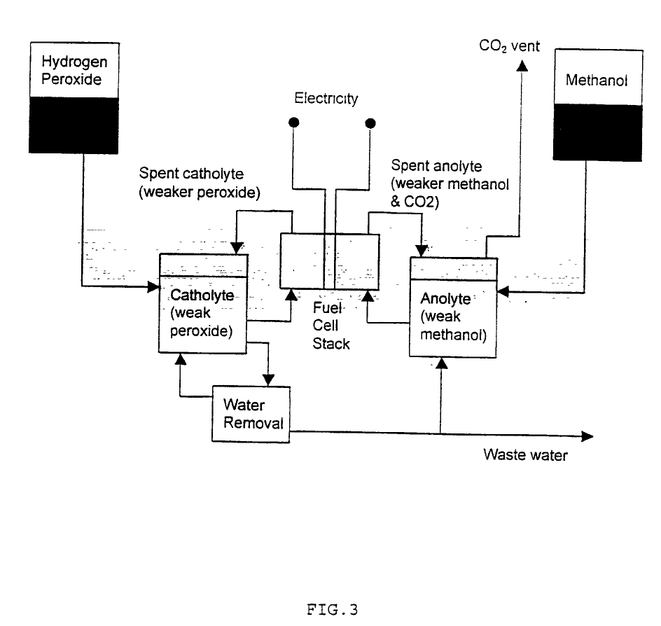

The block diagram shown FIG. 3 illustrates the operation of fuel cell 8. Specifically, hydrogen peroxide and water are added to the cathode side of the fuel cell, and methanol and water are added to the anode side of the fuel cell, to produce electric current by the flow of protons, i.e., proton transfer, over the anode/cathode membrane.

As shown in FIG. 2 and FIG. 3, methanol and hydrogen peroxide solutions must be added periodically to each of the anode and the cathode sides of the fuel cell, respectively, usually by an automatic computer controlled system. Importantly, the concentrations of each of the solutions must be within a predetermined range, in order to achieve satisfactory operation of the fuel cell. Therefore, the concentration of the solutions must be monitored and adjusted before injection thereof into the fuel cells.

What is claimed is:

1. A direct hydrogen peroxide fuel cell, comprising:
a first compartment having a first end with at least one input orifice and at least one output orifice disposed therein, and a second open end;
an anode disposed adjacent and in contact with the second open end of the first compartment;
an ion-conducting membrane disposed adjacent to and in contact with the anode;
a cathode disposed adjacent to and in contact with the ion conducting membrane and electrically connected to the anode; and
a second compartment having a first end with at least one input orifice and at least one output orifice disposed therein, and a second open end disposed adjacent to and in contact with the cathode.

2. The direct hydrogen peroxide fuel cell of claim 1, wherein the first compartment additionally contains a proton-donating fuel.

3. The direct hydrogen peroxide fuel cell of claim 1, wherein the anode is comprised of a porous and electrically conductive substrate.

4. The direct hydrogen peroxide fuel cell of claim 3, wherein the anode further comprises an ion-conducting polymer impregnated therein.

5. The direct hydrogen peroxide fuel cell of claim 1, wherein the ion conducting membrane is NAFION.

6. The direct hydrogen peroxide fuel cell of claim 1, wherein the cathode is comprised of a metal, an inorganic matrix, or metal containing organic compound, or an enzyme, said enzyme capable of catalyzing the reduction of hydrogen peroxide.

7. The direct hydrogen peroxide fuel cell of claim 1, wherein the cathode or anode, or both, contain a metal selected from the group consisting of ruthenium, rhodium, palladium, osmium, iridium and platinum, or a mixture thereof, to catalyze the reduction of hydrogen peroxide or the oxidation of fuel, respectively.

8. The direct hydrogen peroxide fuel cell of claim 6, wherein the cathode further comprises a conductive and porous substrate.

9. The direct hydrogen peroxide fuel cell of claim 1, wherein the cathode is comprised of an enzyme as an electrocatalyst.

10. The direct hydrogen peroxide fuel cell of claim 9, wherein said enzyme is an enzyme from the peroxidase class of enzymes.

11. The direct hydrogen peroxide fuel cell of claim 9, wherein the cathode further comprises a substrate attached to the enzyme, to facilitate either electron or proton transfer between the electrode and the electrocatalyst, or both.

12. The direct hydrogen peroxide fuel cell of claim 11, wherein the cathode further comprises a conductive binder.

13. The direct hydrogen peroxide fuel cell of claim 12, wherein the binder is a porous, inert, and ion-conductive polymer.

14. The direct hydrogen peroxide fuel cell of claim 1, wherein the cathode is comprised of an organometallic molecule.

15. The direct hydrogen peroxide fuel cell of claim 9, wherein the cathode is comprised of a catalase.

16. The direct hydrogen peroxide fuel cell of claim 14, , the cathode further comprises a substrate attached to the organometallic molecule or enzyme.

17. The direct hydrogen peroxide fuel cell of claim 16, further comprising a proton donor liquid reservoir flowably connected to the input orifice of the first compartment, for holding and supplying a proton donor liquid to the fuel cell via the input orifice.

18. The direct hydrogen peroxide fuel cell of claim 1, further comprising a proton acceptor liquid reservoir flowably connected to the input orifice of the second compartment, for holding and supplying a proton acceptor liquid to the fuel cell via the input orifice.

19. The direct hydrogen peroxide fuel cell of claim 18, wherein the proton acceptor fluid comprises hydrogen peroxide.

20. The direct hydrogen peroxide fuel cell of claim 1, further comprising a receiving reservoir flowably connected to the output orifice of the first compartment.

21. The direct hydrogen peroxide fuel cell of claim 1, further comprising a receiving reservoir flowably connected to the output orifice of the second compartment.

22. The direct hydrogen peroxide fuel cell of claim 18, wherein the proton acceptor liquid reservoir comprises a hydrogen peroxide concentration sensor.

23. The direct hydrogen peroxide fuel cell of claim 1, wherein the anode comprises dehydrogenases.

24. The direct hydrogen peroxide fuel cell of claim 1, wherein the anode comprises synthetic molecules which display dehydrogenase-like catalytic activity.

25. The direct hydrogen peroxide fuel cell of claim 2, wherein the proton-donating fuel is methanol, methane, or a logistic fuel such as gasoline or kerosene, which is mixed with water.

26. The direct hydrogen peroxide fuel cell of claim 2, wherein the second compartment contains hydrogen peroxide and water.

27. The direct hydrogen peroxide fuel cell of claim 3, wherein the porous and electrically conductive substrate is selected from the group consisting of fritted carbon, carbon cloth, fritted metals and woven metals.

28. The direct hydrogen peroxide fuel cell of claim 6, wherein the metal containing organic compound is selected from the group consisting of metallo-porphyins, chelated metal moieties, organo-metallics.

29. The direct hydrogen peroxide fuel cell of claim 12, wherein the conductive binder is comprised of a substituted synthetic zeolite, or a conducting polymer.

30. The direct hydrogen fuel cell of claim 13, wherein the binder is NAFION.

31. The direct hydrogen peroxide fuel cell of claim 14, wherein the organometallic molecule is selected from the group consisting of metallo-porphyins, chelated metals and organo-metallic species.

32. The direct hydrogen peroxide fuel cell of claim 7, wherein the cathode further comprises a fritted or woven carbon and a metallic species.

33. The direct hydrogen peroxide fuel cell of claim 15, wherein the cathode further comprises a substrate attached to the organometallic molecule or enzyme.
